(19) United States
(12) Patent Application Publication
(10) Pub. No.: US 2008/0019249 A1
(43) Pub. Date: Jan. 24, 2008

(54) APPARATUS FOR REPRODUCING DATA ON RECORDING MEDIUM AND METHOD FOR REPRODUCING DATA ON THE MEDIUM

(75) Inventors: Yukiyasu Tatsuzawa, Yokohama-Shi (JP); Hideyuki Yamakawa, Kawasaki-Shi (JP); Koichi Otake, Yokohama-Shi (JP); Norikatsu Chiba, Kawasaki-Shi (JP); Yasuhiro Kanishima, Tokyo (JP); Toshifumi Yamamoto, Kanagawa-Ken (JP); Toshihiko Kaneshige, Yokohama-Shi (JP)

Correspondence Address: KNOBBE MARTENS OLSON & BEAR LLP, 2040 MAIN STREET, FOURTEENTH FLOOR, IRVINE, CA, 92614, US

(73) Assignee: Toshiba Corporation, Minato-Ku (JP)

(21) Appl. No.: 11/771,906

(22) Filed: Jun. 29, 2007

(30) Foreign Application Priority Data
Jun. 30, 2006 (JP) 2006181619

(51) Int. Cl. G11B 5/09

(52) U.S. Cl. 369/59.22

(57) ABSTRACT

An apparatus for reproducing digital data recorded on a recording medium by a Partial Response Maximum Likelihood method, the digital data being recorded in a code pattern in which the same code continuously appears at least two times, includes an analog-to-digital converting unit that samples an analog reproduction signal recorded on the recording medium and converts the sampled analog reproduction signal into a digital signal; a sampling rate switching unit that adaptively switches the sampling rate in the analog-to-digital converting unit from a higher rate to a lower rate; and a data demodulating unit that reproduces and demodulates the digital signal subjected to the analog-to-digital conversion in the analog-to-digital converting unit by the Partial Response Maximum Likelihood method in accordance with the switching between the higher rate and the lower rate.

### CROSS-REFERENCE TO RELATED APPLICATIONS

This application claims the benefit of priority of Japanese Patent Application No. 2006-181619, filed Jun. 30, 2006, the entire contents of which are incorporated herein by reference.

### BACKGROUND

1. Field

The present invention relates to apparatuses for reproducing data on recording media and methods for reproducing data on the recording media. More particularly, the present invention relates to an apparatus for reproducing data on a recording medium and a method for reproducing data on the recording medium, which perform analog-to-digital conversion (A/D conversion) to a reproduction signal to process the converted reproduction signal.

2. Description of the Related Art

High definition (HD) digital versatile disk (DVD) players playing back HD videos recorded on HD DVDs, which are high-capacity optical discs, have been in widespread use in recent years. Such an HD DVD player uses a blue-violet laser beam having a wavelength of 405 nm to read data on an HD DVD. HD DVD-read only memory (ROM) has a single-layer capacity of 15 GB and a dual-layer capacity of 30 GB. Rewritable HD DVD-random access memory (RAM) has a single-layer capacity of 20 GB. In order to realize these high capacities, the HD DVD players use laser beams having shorter wavelengths and adopts Partial Response Maximum Likelihood (PRML) technology as the signal processing method for reproduction of data.

The PRML technology is disclosed in, for example, JP-A 2001-195830. The PRML technology will now be briefly described.

Partial Response (PR) is provided as a method for carrying out data reproduction while compressing a necessary signal bandwidth by actively utilizing intersymbol interference (interference between reproduction signals corresponding to bits that are recorded side by side). The PR can be further classified into multiple types and classes depending on how the intersymbol interference occurs. For example, in the case of Class 1, reproduction data is reproduced as two-bit data “11” in response to recording data “1” to cause the intersymbol interference to occur in the subsequent one bit. Viterbi decoding algorithm is one kind of a maximum likelihood sequence estimation scheme. This scheme effectively utilizes a rule on the intersymbol interference of a reproduced waveform to reproduce data on the basis of information concerning signal amplitudes at multiple points of times. In order to perform the reproduction, a synchronizing clock is generated in synchronization with a reproduced waveform obtained from a recording medium and the reproduced waveform is sampled in response to the synchronization clock to convert the sampled waveform into amplitude information.

Then, appropriate waveform equalization is performed to convert the amplitude information into a response waveform of a predetermined partial response. Past sample data and current sample data are used in a Viterbi decoding unit to output the most probable data sequence as the reproduction data. Combination of the partial response method and the Viterbi decoding algorithm (maximum likelihood decoding), described above, is referred to as a PRML method. In order to realize this PRML technology, it is necessary to use an adaptive equalization technique with a high precision and a clock recovery technique with a high precision supporting the adaptive equalization technique so that the reproduction signal is produced as a response of a predetermined PR class.

Run Length Limited (RLL) codes for use in the PRML technology will now be described. In a PRML reproducing circuit, a clock signal in synchronization with a reproduction signal reproduced from the recording medium is generated from the reproduction signal itself. In order to generate a stable clock signal, it is necessary to invert the signal recorded on the recording medium in polarity within a predetermined time period. At the same time, the polarity of the reproduction signal is prevented from being inverted during a predetermined time period in order to decrease the maximum frequency of the recorded signal. A maximum data length in which the polarity of the reproduction signal is not inverted is referred to as a maximum run length, and a minimum data length in which the polarity of the reproduction signal is not inverted is referred to as a minimum run length.

For example, a modulation rule in which the maximum run length is seven bits and the minimum run length is one bit is represented by (1,7)RLL. A code having a modulation rule of (1,7)RLL is also called “min-2T-system code” because a minimum value (Tmin) in length in which the same code continuously appears is equal to “2T” when the code has a unit length of “T”.

A modulation rule in which the maximum run length is seven bits and the minimum run length is two bits is represented by (2,7)RLL. A code having a modulation rule of (2,7)RLL is also called “min-3T-system code” because Tmin is equal to “3T”.

Typical modulation and demodulation schemes used in the optical discs include Eight to Twelve Modulation (ETM) for the min-2T-system code used in the HD DVDs and Eight to Sixteen Modulation (EFM Plus) for the min-3T-system code used in DVDs in related art.

Reproducing circuits adopting the PRML technology are expected to have greatly improved reproduction performance at higher recording densities, compared with reproducing circuits adopting binary slicing (circuits in which analog reproduction signals are not subjected to the A/D conversion and are sliced and binarized by using appropriate thresholds). Accordingly, the HD DVD standard adopts the PRML technology to further improve the linear recording densities.

However, the signal processing circuits adopting the PRML technology are greatly increased in size because of the complicated configurations, compared with the reproducing circuits adopting the binary slicing. Accordingly, how the power consumption during operation is reduced is a big technical problem for the PRML signal processing circuits. Particularly, since the power consumption of analog-to-digital converters (ADCs) forms a larger proportion of the power consumption of the entire signal processing circuits and the sampling rates of the ADCs are proportionally increased at higher double speeds, it is desirable to achieve power saving in the ADCs.

An approach to this technical problem about the power consumption is a half rate technology disclosed in, for example, JP-A 2002-269925.

The technology disclosed in JP-A 2002-269925 is based on the eight-to-sixteen modulation (EFM plus) scheme using the “min-3T-system code”, adopted in the DVDs in the related art. In this technology, little presence of signal bandwidths having frequencies higher than one-fourth of a channel rate Fch in mutual transfer function (MTF) characteristics, as in an example shown in FIG. 1A, is utilized to perform the reproduction with the sampling rate of the ADC being set to a half (half rate) of the channel rate. Degradation in performance possibly occurs in phase control, offset control, adaptive equalizers, Viterbi decoders, and so on because the amount of information concerning time-base components is reduced although this sampling rate is sufficient for the reproduction according to the sampling theorem.

Accordingly, in the technology disclosed in JP-A 2002-269925, both a channel-rate data demodulating unit that uses the channel rate to reproduce data and a half rate data demodulating unit that uses the half rate to reproduce data are provided and either of the data modulating units is selected depending on the signal quality in order to resolve the problem of the degradation in performance.

However, since the technology disclosed in JP-A 2002-269925 restricts application thereof to the min-3T-system code, it is not possible to directly apply this half rate technology to the HD DVDs adopting the min-2T-system code.

This is because, in the min-2T-system code adopted in the HD DVDs, the frequency components in areas having frequencies higher than 2T frequency (a one-fourth of the channel rate Fch) exist in the signal bandwidth, as shown in FIG. 1B. Accordingly, simply performing this half rate processing can produce an aliasing noise to cause a greater degradation in performance involved in the half rate processing, compared with cases where the DVDs in the related art are adopted.

Also in a phase control loop, the effect of the reduction in the amount of information concerning the time-base components apparently appears in the min-2T-system code, compared with the min-3T-system code. Accordingly, the operational stability can be threatened with the technology disclosed in JP-A 2002-269925.

Furthermore, the technology disclosed in JP-A 2002-269925 has a problem about a switching shock in rate switching.

The rate switching before data transfer (an operation of reproducing user data recorded on the optical disc and transferring the reproduced user data to, for example, a computer) has no problem because frequency acquisition, phase acquisition, adaptive learning, and the like are performed again after the rate switching. However, the rate switching during the data transfer can cause a loss of the user data or can damage the user data due to the switching shock. Consequently, there is room for improvement in the technology disclosed in JP-A 2002-269925.

### SUMMARY OF THE INVENTION

Accordingly, it is an object of the present invention to provide an apparatus for reproducing data on a recording medium and a method for reproducing data on the recording medium, which are capable of switching from a normal sampling rate to a lower sampling rate even in the min-2T-system code used in HD DVDs and others without spoiling the operational stability to reduce the power consumption.

According to an embodiment of the present invention, an apparatus for reproducing digital data recorded on a recording medium by a Partial Response Maximum Likelihood method, the digital data being recorded in a code pattern in which the same code continuously appears at least two times, includes an analog-to-digital converting unit that samples an analog reproduction signal recorded on the recording medium and converts the sampled analog reproduction signal into a digital signal; a sampling rate switching unit that adaptively switches the sampling rate in the analog-to-digital converting unit from a higher rate to a lower rate; and a data demodulating unit that reproduces and demodulates the digital signal subjected to the analog-to-digital conversion in the analog-to-digital converting unit by the Partial Response Maximum Likelihood method in accordance with the switching between the higher rate and the lower rate.

According to another embodiment of the present invention, an apparatus for reproducing digital data recorded on a recording medium by a Partial Response Maximum Likelihood method includes an analog-to-digital converting unit that samples an analog reproduction signal recorded on the recording medium and converts the sampled analog reproduction signal into a digital signal; a sampling rate switching unit that adaptively switches the sampling rate in the analog-to-digital converting unit from a higher rate to a lower rate; and a data demodulating unit that reproduces and demodulates the digital signal subjected to the analog-to-digital conversion in the analog-to-digital converting unit by the Partial Response Maximum Likelihood method in accordance with the switching between the higher rate and the lower rate. The sampling rate switching unit switches the sampling rate from the higher rate to the lower rate during a period other than the period when user data is reproduced.

According to another embodiment of the present invention, an apparatus for reproducing digital data recorded on a recording medium by a Partial Response Maximum Likelihood method includes an analog-to-digital converting unit that samples an analog reproduction signal recorded on the recording medium and converts the sampled analog reproduction signal into a digital signal; a sampling rate switching unit that adaptively switches the sampling rate in the analog-to-digital converting unit from a higher rate to a lower rate; and a data demodulating unit that reproduces and demodulates the digital signal subjected to the analog-to-digital conversion in the analog-to-digital converting unit by the Partial Response Maximum Likelihood method in accordance with the switching between the higher rate and the lower rate. The data demodulating unit selects different partial response classes, used in the Partial Response Maximum Likelihood method, at the higher rate and at the lower rate.

According to another embodiment of the present invention, an apparatus for reproducing digital data recorded on a recording medium by a binary slicing method and a Partial Response Maximum Likelihood method includes a first data demodulating unit that includes an analog-to-digital converting unit sampling an analog reproduction signal recorded on the recording medium and converting the sampled analog reproduction signal into a digital signal and that reproduces and demodulates the digital signal subjected to the analog-to-digital conversion in the analog-to-digital converting unit by the Partial Response Maximum Likelihood method; a second data demodulating unit that slices the analog reproduction signal into a binary value and demodulates the binary value; and a demodulation selecting unit that, at least if the second data demodulating unit is selected, stops the operation of the first data demodulating unit to selectively perform switching between the first data demodulating unit and the second data demodulating unit.

According to another embodiment of the present invention, a reproducing method for an apparatus for reproducing digital data recorded on a recording medium by a Partial Response Maximum Likelihood method, the digital data being recorded in a code pattern in which the same code continuously appears at least two times, includes the steps of sampling an analog reproduction signal recorded on the recording medium and converting the sampled analog reproduction signal into a digital signal; adaptively switching the sampling rate in the analog-to-digital conversion from a higher rate to a lower rate; and reproducing and demodulating the digital signal subjected to the analog-to-digital conversion by the Partial Response Maximum Likelihood method in accordance with the switching between the higher rate and the lower rate.

According to another embodiment of the present invention, a reproducing method for an apparatus for reproducing digital data recorded on a recording medium by a Partial Response Maximum Likelihood method includes the steps of sampling an analog reproduction signal recorded on the recording medium and converting the sampled analog reproduction signal into a digital signal; adaptively switching the sampling rate in the analog-to-digital conversion from a higher rate to a lower rate; and reproducing and demodulating the digital signal subjected to the analog-to-digital conversion by the Partial Response Maximum Likelihood method in accordance with the switching between the higher rate and the lower rate. The switching step switches the sampling rate from the higher rate to the lower rate during a period other than the period when user data is reproduced.

According to another embodiment of the present invention, a reproducing method for an apparatus for reproducing digital data recorded on a recording medium by a Partial Response Maximum Likelihood method includes the steps of sampling an analog reproduction signal recorded on the recording medium and converting the sampled analog reproduction signal into a digital signal; adaptively switching the sampling rate in the analog-to-digital conversion from a higher rate to a lower rate; and reproducing and demodulating the digital signal subjected to the analog-to-digital conversion by the Partial Response Maximum Likelihood method in accordance with the switching between the higher rate and the lower rate. The reproducing and demodulating step selects different partial response classes, used in the Partial Response Maximum Likelihood method, at the higher rate and at the lower rate.

According to another embodiment of the present invention, a reproducing method for an apparatus for reproducing digital data recorded on a recording medium by a binary slicing method and a Partial Response Maximum Likelihood method includes a first data demodulating step of reproducing and demodulating a digital signal subjected to analog-to-digital conversion in an analog-to-digital converting unit by the Partial Response Maximum Likelihood method, the analog-to-digital converting unit sampling an analog reproduction signal recorded on the recording medium and converting the sampled analog reproduction signal into the digital signal; a second data demodulating step of slicing the analog reproduction signal into a binary value and demodulating the binary value; and a demodulation selecting step of stopping the first data demodulating step, at least if the second data demodulating step is selected, to selectively perform switching between the first data demodulating step and the second data demodulating step.

According to the apparatuses for reproducing data on recording media and the methods for reproducing data on the recording media, it is possible to switch from the normal sampling rate to the lower sampling rate even in the min-2T-system code used in HD DVDs and others without spoiling the operational stability to reduce the power consumption.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1A is a graph showing examples of MTF characteristics of a min-3T-system code and FIG. 1B is a graph showing examples of the MTF characteristics of a min-2T-system code;

FIG. 2 is a block diagram showing an example of the configuration of an apparatus for reproducing data on a recording medium according to a first embodiment of the present invention;

FIG. 3 shows an example of a waveform equalization characteristic in a pre-equalizer;

FIG. 4 is a block diagram showing an example of the operational concept of an adaptive equalizer in detail;

FIGS. 5A and 5B show an example of the operation of the adaptive equalizer at a channel rate and a half rate;

FIG. 6A is a graph showing the relationship between MTF characteristics and PR characteristics of the min-3T-system code and FIG. 6B is a graph showing the relationship between the MTF characteristics and the PR characteristics of the min-2T-system code;

FIG. 7 is a flowchart showing an example of a switching process between a higher rate and a lower rate in frequency and phase acquisition;

FIG. 8 is a flowchart showing an example of a process of switching a sampling rate on the basis of a signal quality;

FIG. 9 is a flowchart showing an example of a switching process between the lower rate and the higher rate during data transfer;

FIGS. 10A and 10B show the concept of a VFO area included in a reproduction signal;

FIG. 11 illustrates the operational concept of a VFO area detection circuit;

FIGS. 12A to 12D illustrate how the VFO area is detected from a wobble signal;

FIG. 13 is a block diagram showing an example of the configuration of an apparatus for reproducing data on a recording medium according to a second embodiment of the present invention;

FIG. 14 is a block diagram showing an example of the configuration of an apparatus for reproducing data on a recording medium according to a third embodiment of the present invention;

FIG. 15 is a block diagram showing an example of the configuration of an apparatus for reproducing data on a recording medium according to a fourth embodiment of the present invention;

FIG. 16 is a flowchart showing an example of a reproduction operation of the reproducing apparatus according to the fourth embodiment of the present invention; and

FIG. 17 shows examples of the relationship between a linear density and a BER in different signal processing methods.

### DETAILED DESCRIPTION

Apparatuses for reproducing data on recording media and methods for reproducing data on the recording media according to embodiments of the present invention will be described with reference to the attached drawings.

### First Embodiment

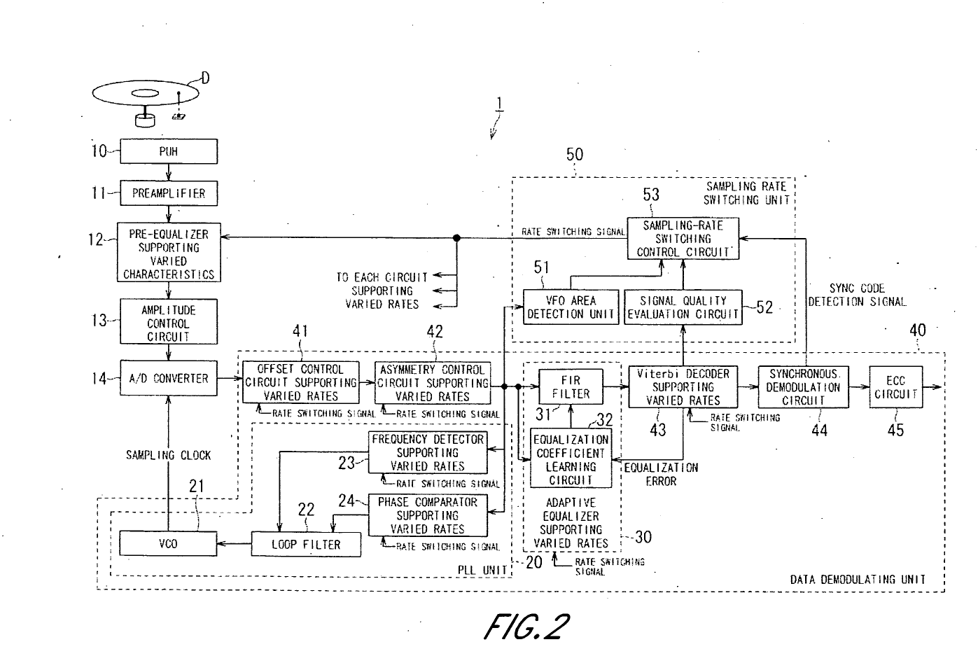

FIG. 2 is a block diagram showing an example of the configuration of an apparatus 1 for reproducing data on a recording medium (hereinafter referred to as a reproducing apparatus 1) according to a first embodiment of the present invention. The reproducing apparatus 1 reproduces min-2T-system code digital data recorded on a recording medium D, for example, an optical disc such as an HD DVD.

The reproducing apparatus 1 according to the first embodiment of the present invention is of a synchronous type in which switching between a higher rate and a lower rate is performed to sample analog reproduction signals recorded on the recording medium.

The synchronous type means that the higher sampling rate in the A/D conversion is synchronized with a channel rate (a reproduction rate in units of bits recorded on the recording medium). An operating clock in digital processing after the A/D conversion is also synchronized with a sampling clock in the synchronous reproducing apparatus 1. The synchronous type is generally used in the PRML signal processing.

At the lower rate, the analog reproduction signals are sampled at a sampling clock lower than the higher rate (the channel rate in this case). It is assumed that the lower rate is equal to the half rate (half of the channel rate) in the following description. However, the lower rate is not limited to the half rate.

Referring to FIG. 2, the reproducing apparatus 1 includes a pickup head (PUH) 10, a preamplifier 11, a pre-equalizer 12 supporting varied characteristics, an amplitude control circuit 13, an A/D converter 14, a data demodulating unit 40, and a sampling rate switching unit 50.

The data demodulating unit 40 includes, as internal components, a phase locked loop (PLL) unit 20, an offset control circuit 41 supporting varied rates, an asymmetry control circuit 42 supporting varied rates, an adaptive equalizer 30 supporting varied rates, a Viterbi decoder 43 supporting varied rates, a synchronous demodulation circuit 44, and an error correcting code (ECC) circuit 45.

The PLL unit 20 includes, as internal components, a frequency detector 23 supporting varied rates, a phase comparator 24 supporting varied rates, a loop filter 22, and a voltage controlled oscillator (VCO) 21. The adaptive equalizer 30 includes, as internal components, a finite impulse response (FIR) filter 31 and an equalization coefficient learning circuit 32.

The sampling rate switching unit 50 includes, as internal components, a variable frequency oscillator (VFO) area detection circuit 51, a signal quality evaluation circuit 52, and a sampling-rate switching control circuit 53.

An operation of the reproducing apparatus 1 having the above configuration will now be described.

The recording medium D is irradiated with a laser beam emitted from the PUH 10 with reproduction laser power. The PUH 10 detects light reflected from the recording medium D to output an analog reproduction signal. The analog reproduction signal output from the PUH 10 is supplied to the preamplifier 11 where the analog reproduction signal is subjected to, for example, signal amplification.

The pre-equalizer 12 performs pre-equalization of waves. The waveform equalization characteristics are formed by, for example, a seventh-order equiripple filter. A preferable cutoff frequency, boost frequency, amount of boost are set for each rate in response to a rate switching signal supplied from the sampling-rate switching control circuit 53 and the waveform equalization is performed.

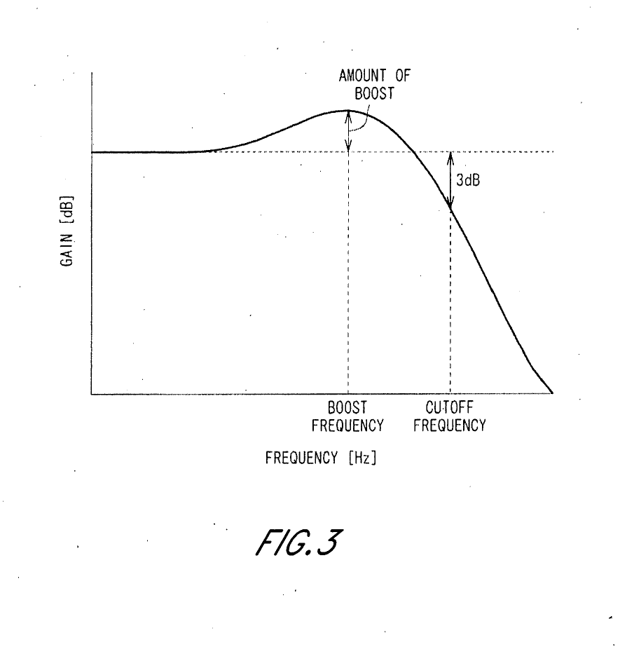

FIG. 3 shows an example of the waveform equalization characteristic in the pre-equalizer 12. Parameters including the cutoff frequency, the boost frequency, and the amount of boost are shown in FIG. 3.

At the higher rate (at the channel rate), it is desirable to set the waveform equalization characteristics so as to boost signal components near the 2T frequency component. In contrast, at the half rate, the waveform equalization characteristics are set such that the cutoff frequency is reduced to remove the signal components in a higher frequency range and to suppress the effect of the aliasing noise as much as possible.

However, since removing the signal components in the higher frequency range too much increases a bit error rate (bER), it is preferable to evaluate the bER in advance so that the removal of the aliasing noise is balanced with the removal of the signal components.

The amplitude control circuit 13 adjusts the amplitude of the signal subjected to the waveform equalization. The A/D converter 14 converts the analog reproduction signal into a digital value.

The PLL unit 20 extracts the sampling clock from the reproduction signal itself such that the appropriate sampling timing is yielded. Specifically, the frequency detector 23 detects a difference in frequency between the reproduced waveform and the channel rate or the half rate and the phase comparator 24 detects a difference in phase between the reproduced waveform and an ideal sampling point to control the frequency and the phase.

Both the frequency and the phase are controlled by the loop filter 22. The VCO 21 generates the sampling clock. The sampling clock is supplied to the A/D converter 14 in synchronization with the channel rate at the higher rate while the half-frequency clock is supplied to the A/D converter 14 at the half rate.

Since the precision of information concerning the detected phase is lowered at the half rate in the phase control loop, upsampling may be performed using an interpolation circuit at the half rate to increase the amount of information in order to improve the stability.

The offset control circuit 41 and the asymmetry control circuit 42 perform digital waveform shaping to the digital signal. The offset control circuit 41 is configured so as to set the duty ratio of the signal components to a predetermined value. In this case, since the offset control circuit 41 is capable of operating in principle at both the channel rate and the half rate although the precision can be varied, the offset control circuit 41 can support varied rates.

The asymmetry control circuit 42 is configured, for example, so as to detect the average value of the reproduction signal subjected to the offset adjustment to detect the asymmetry of the signal in the amplitude direction. In this case, since the asymmetry control circuit 42 is capable of asynchronously operating although the precision can be varied, the asymmetry control circuit 42 can support varied rates.

The adaptive equalizer 30 performs waveform equalization to the waveform resulting from the digital waveform shaping in the offset control circuit 41 and the asymmetry control circuit 42 so as to make a response in a predetermined PR class, typified by a PR(3443) response.

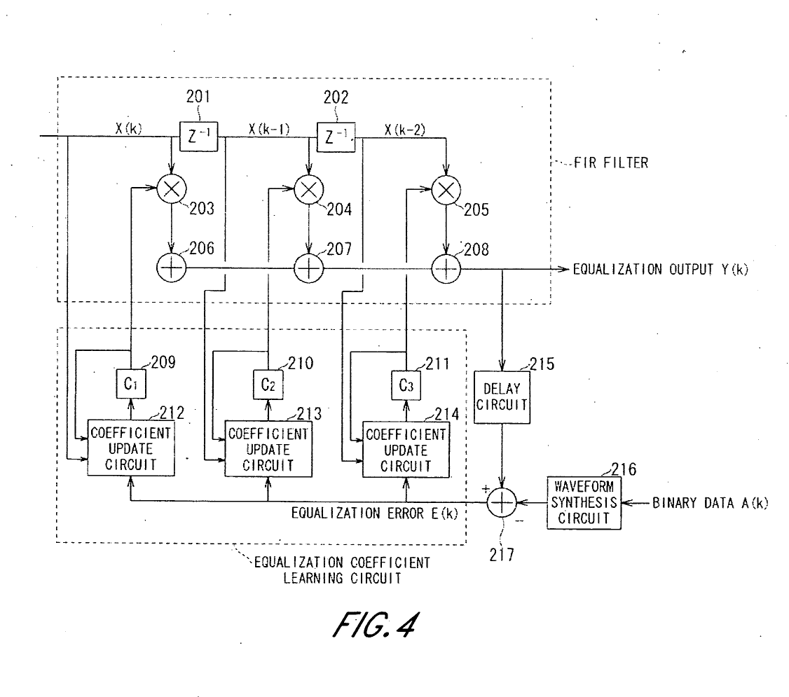

Specific configurations of the adaptive learning process are described in many documents including JP-A 2001-195830. An adaptive learning method by using the most common least mean square (LMS) algorithm will now be described with reference to FIG. 4.

FIG. 4 is a block diagram showing an example of the operational concept of the adaptive equalizer in detail. The adaptive equalizer in FIG. 4 includes the FIR filter 31 and the equalization coefficient learning circuit 32 shown in FIG. 2 and also includes the processing (equalization error generation) in the Viterbi decoder 43 for convenience.

Referring to FIG. 4, one-clock delay devices 201 and 202, which are flip-flops, each delay an input signal for one clock to output the delayed signal. Multiplier circuits 203, 204, and 205 each output a product of two input values. Adder circuits 206, 207, and 208 each output a sum of two input values.

Although a three-tap digital filter using the three multiplier circuits is exemplified in FIG. 4, the adaptive equalizer basically operates in the same manner as in FIG. 4 if the number of the multiplier circuits is varied.

An output Y(k) from the adaptive equalizer is calculated according to Equation (1):
Y(k)=x(k)*c1+x(k−1)*c2+x(k−2)*c3 (1)

where an input signal into the adaptive equalizer at a time k is denoted by x(k) and the coefficients input into the multiplier circuits 203, 204 and 205 are denoted by c1, c2, and c3, respectively.

The desired output Z(k) from the adaptive equalizer at the time k is calculated according to Equation (2), provided that a target PR class is, for example, PR(3443) and binary data A(k) is yielded by the Viterbi decoder 43 for the output Y(k) correctly.:
Z(k)=3*A(k)+4*A(k−1)*4*A(k−2)+3*A(k−3)−7 (2)

An equalization error E(k) at the time k is defined by Equation (3):
E(k)=Y(k)−Z(k) (3)

In the adaptive learning, the coefficients of the multiplier circuits are updated according to Equations (4) to (6).
c1(k+1)=C1(k)−α*x(k)*E(k) (4)
c2(K+1)=c2(k)−α*x(k−1)*E(k) (5)
c3(K+1)=c3(k)−α*x(k−2)*E(k) (6)

“α” in Equation (4) to (6) denotes an update coefficient and is set to a small positive value (for example, 0.01). The process shown in Equation (2) is performed by a waveform synthesis circuit 216. A delay circuit 215 delays the output Y(k) from the adder circuit 208 for a time corresponding to the processing time in the Viterbi decoder 43. An adder circuit 217 performs the processing shown in Equation (3). A coefficient update circuit 212 performs the processing shown in Equation (4) to update the coefficient of the multiplier circuit 203. The update result is stored in a register 209. A coefficient update circuit 213 performs the processing shown in Equation (5) to update the coefficient of the multiplier circuit 204. The update result is stored in a register 210. A coefficient update circuit 214 performs the processing shown in Equation (6) to update the coefficient of the multiplier circuit 205. The update result is stored in a register 211.

The adaptive learning is performed in the above manner. However, in order to support varied rates in the adaptive learning, it is necessary to introduce some schemes.

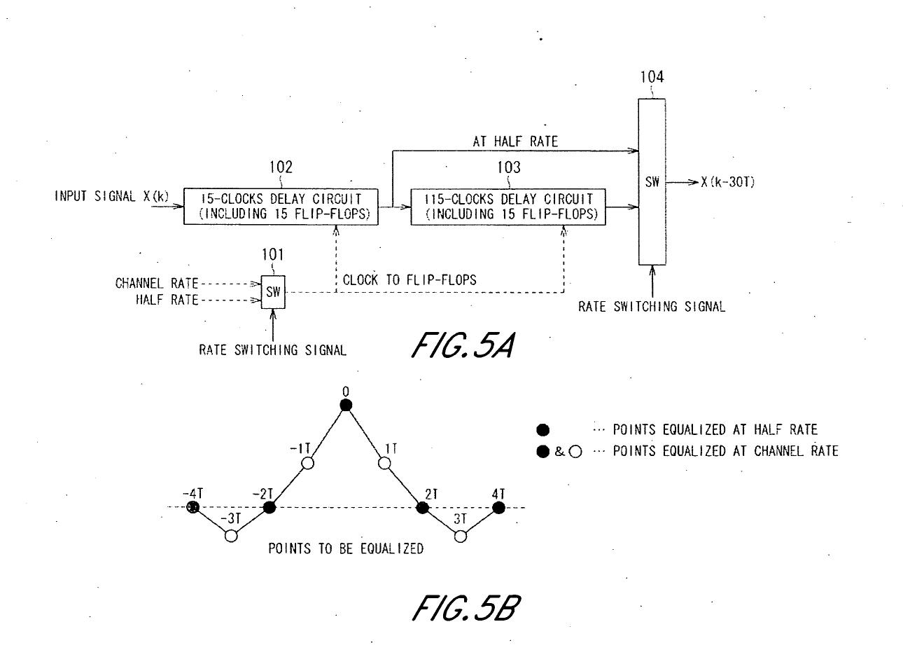

The adaptive equalizer 30 includes many delay circuits, such as the coefficient update circuits 212 to 214, for adjusting the delay corresponding to the processing time in the Viterbi decoder 43. The number of flip-flops should be switched between at the channel rate and at the half rate. For example, when a delay of 30T occurs in the Viterbi decoder 43, 30 flip-flops are necessary at the channel rate while, at the half rate, it is enough to provide 15 flip-flops at the half rate to realize the delay 30T because one clock corresponds to a delay of 2T. Accordingly, as shown in FIG. 5A, the adaptive equalizer 30 is configured so as to use the outputs from the fifteen flip-flops of a 15-clocks delay circuit 102 at the half rate. Meanwhile, at the channel rate, both the 15-clock delay circuit 102 and 103 are used by the selecting switch 104 and 101.

As shown in FIG. 5B, the tap coefficients of the FIR filter 31 in the adaptive equalizer 30 correspond to the equalization coefficients (points represented by ● and ◯) plotted on the waveform for every 1T at the channel rate while the tap coefficients of the FIR filter 31 in the adaptive equalizer 30 correspond to the equalization coefficients (points represented by ◯) plotted on the waveform for every 2T at the half rate. The converging equalization coefficients are varied for every rate in the above manner.

Accordingly, it is necessary to switch the operation of the equalization coefficients between at the channel rate and at the half rate. It is also necessary to separately set the initial equalization coefficients, which are very important in the adaptive learning, at the channel rate and the half rate.

Referring back to FIG. 2, the signal output adaptively equalized to a desired PR class is supplied from the adaptive equalizer 30 to the Viterbi decoder 43. The Viterbi decoder 43 performs maximum likelihood sequence estimation (Viterbi decoding) to the input data to output binary data. It is necessary to output the binary data at the channel rate independently of the sampling rate.

Specifically, it is necessary to operate the Viterbi decoder 43 in response to the operating clock in synchronization with the channel rate even at the lower rate to supply the binary data to the downstream components (it is necessary to finally be in synchronization with the channel rate although the Viterbi decoder 43 can operate at the lower rate during some of the internal processings).

Accordingly, the Viterbi decoder 43 performs branch metric calculation and path selection every 1T at the channel rate and performs the branch metric calculation and path selection every 2T at the half rate to estimate an intermittent signal on the basis of the selected path.

As disclosed in JP-A 2002-269925, Nyquist interpolation from the half rate to the channel rate may be performed upstream of the Viterbi decoder 43.

The PRML method supporting varied rates is realized in the above manner. Supply of the binary data decoded by the Viterbi decoder 43 to a host apparatus, such as a personal computer, as user data will now be simply described.

The binary data output from the Viterbi decoder 43 is supplied to the synchronous demodulation circuit 44. In the HD DVD, the binary data sequence is recorded in frames each corresponding to 1116-bit data. A synchronization unit in the synchronous demodulation circuit 44 detects 24-bit binary data sequence (SYNC code) representing the start position of each frame to generate a 12-bit synchronization signal for a downstream demodulating unit. The demodulating unit in the synchronous demodulation circuit 44 demodulates the 12-bit binary data into 8-bit reproduction data in accordance with a demodulation rule defined in advance in the ETM. The signal (demodulation data), which is 8-bit data (Byte data), is supplied to the ECC circuit 45.

The ECC circuit 45 corrects an error caused by, for example, any defect on the recording medium D and, then, supplies the user data to the host apparatus.

In order to further improve the performance at each rate, not only the characteristics of the pre-equalizer 12 are switched at each rate but also the PR class set by the Viterbi decoder 43 is switched.

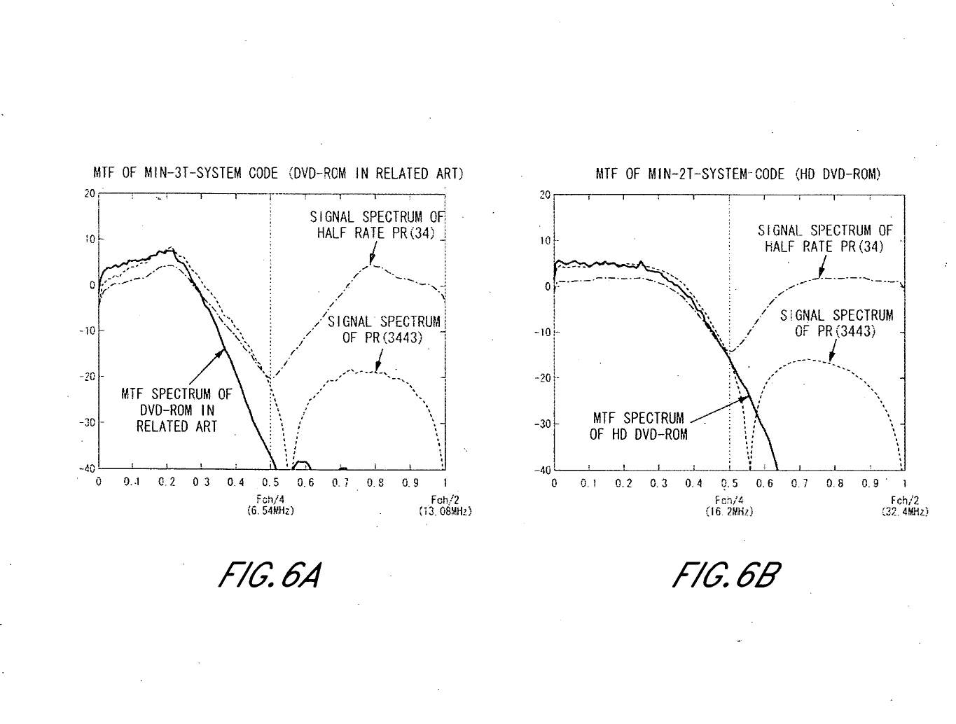

For example, in the case in which a target PR characteristic at the channel rate in the HD DVD is a PR(3443), since the MTF characteristics of the HD DVD is very close to the PR(3443) characteristic, as shown in FIG. 6B, it is possible to achieve a higher reproduction performance at the channel rate.

However, the PR(3443) characteristic is not necessarily optimal at the half rate. This is because it is assumed that the PR(3443) characteristic is formed at the channel rate, as shown in FIG. 6B, and it is not possible to completely form the PR(3443) characteristic at the half rate. Accordingly, a PR characteristic different from the PR(3443) can be used at the half rate to improve the reproduction performance.

A preferred PR characteristic at the half rate is, for example, a PR(34) characteristic resulting from half-rating of the PR(3443) characteristic itself. As shown in FIG. 6B, since the PR(34) characteristic can be formed at the half rate, an improvement in performance can be expected at the half rate.

Generally, it is possible to realize switching between a PR(abba) characteristic at the channel rate and a PR(ab) characteristic at the half rate or switching between a PR(abbba) characteristic at the channel rate and a PR(aba) characteristic at the half rate. However, it is not limited to the switching of a filter characteristic that cannot be formed at the half rate, and only frequency characteristics may be switched. For example, switching between a PR(3443) characteristic and a PR(1221) characteristic may be realized.

The application of the method of switching the PR characteristic in conjunction with the switching of the sampling rate is not limited to the min-2T-system code used in, for example, HD DVDs. This method is applicable to the reproduction of the min-3T-system code used in, for example, DVDs in related art, as shown in FIG. 6A.

### (2) Switching Between Higher Rate and Lower Rate

### Acquisition of Frequency and Phase

Deteriorations in performance at lower rates include a deterioration in detection accuracy in frequency and phase control. Short of time-base components at lower rates has a great effect on the frequency and phase control. In addition, since the data reproduction process cannot be started unless the phase control is finished, an acquisition operation in the frequency and phase control is very important.

According to the first embodiment of the present invention, the reproduction is performed at a higher rate in the frequency and phase acquisition and the higher rate is switched to a lower rate after the acquisition.

As a result, it is possible to maintain a higher accuracy in the frequency and phase detection by performing the acquisition at the higher rate even in the HD DVD adopting the min-2T-system code. Since the capture range can be expanded, it is possible to stabilize the reproduction operation. The higher rate may be set to a rate higher than the channel rate to perform oversampling. In this case, the accuracy can be further increased.

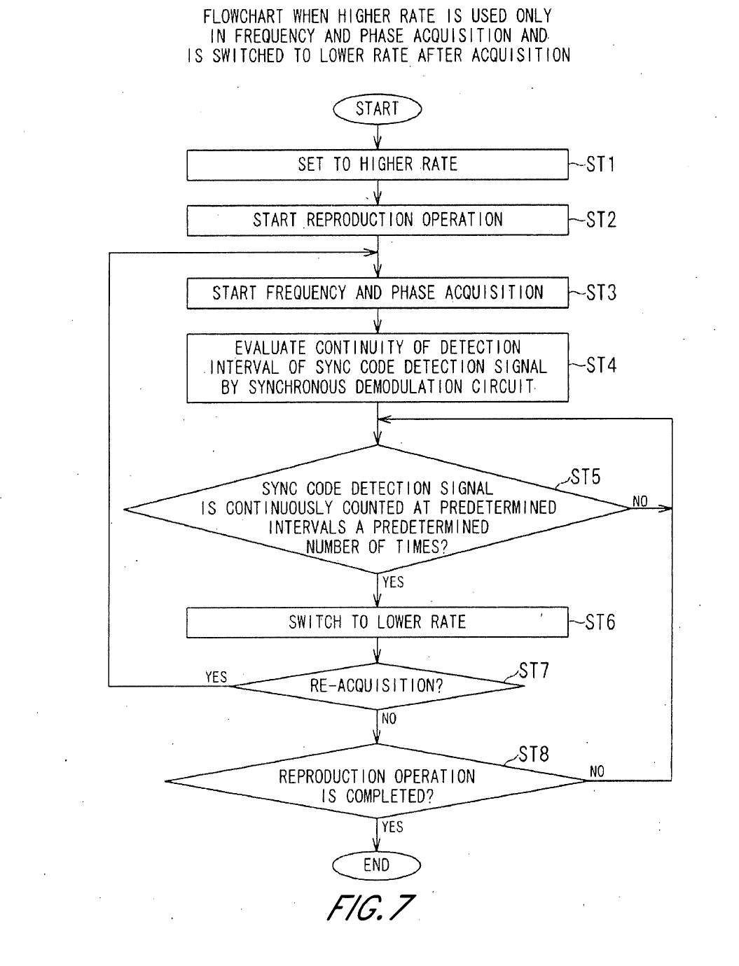

FIG. 7 is a flowchart showing an example of a control process in which the reproduction is performed at the higher rate in the frequency and phase acquisition and the higher rate is switched to the lower rate after the acquisition.

Referring to FIG. 7, in Step ST1, the reproducing apparatus 1 sets the sampling rate to the higher rate as an initial state. In Step ST2, the reproducing apparatus 1 starts the reproduction operation.

In Step ST3, the reproducing apparatus 1 starts the frequency and phase acquisition at the higher rate. Various methods can be used to determine whether the frequency and phase acquisition is completed. For example, a SYNC code detection signal output from the synchronous demodulation circuit 44 may be used.

Specifically, the SYNC code detection signal is supplied from the synchronous demodulation circuit 44 to the sampling-rate switching control circuit 53, as shown in FIG. 2. In Step ST4, the sampling-rate switching control circuit 53 evaluates the continuity of the detection interval of the SYNC code detection signal. In Step ST5, the sampling-rate switching control circuit 53 determines whether the SYNC code detection signal is continuously counted at predetermined intervals a predetermined number of times. If the SYNC code detection signal is continuously counted at predetermined intervals a predetermined number of times, the sampling-rate switching control circuit 53 determines that the acquisition in the phase control is completed. In Step ST6, the sampling-rate switching control circuit 53 outputs a rate switching signal to each component.

The sampling-rate switching control circuit 53 supplies the rate switching signal to each circuit supporting varied rates and to the pre-equalizer 12 supporting varied characteristics. Each circuit supporting varied rates switches the rate of the circuit mode in response to the received rate switching signal. Particularly, the adaptive equalizer 30 resets the current learning value and resets the initial equalization coefficients for every rate in response to the rate switching signal.

The pre-equalizer 12 switches the characteristic for each rate to which the waveform equalization characteristics are set in advance to an optimal characteristic in response to the rate switching signal.

This switching realizes the waveform equalization characteristics in which the cutoff frequency, the boost frequency, and the amount of boost are adapted to the sampling rate.

As described above, performing the reproduction at the higher rate until the frequency and phase are locked and performing the reproduction at the lower rate after the frequency and phase are locked can realize both the stability of the acquisition and low power consumption.

In Step ST7, the reproducing apparatus 1 determines whether it is necessary to acquire the frequency and phase again. If the reproducing apparatus 1 determines that it is necessary to acquire the frequency and phase again because the frequency and phase is unlocked, the reproducing apparatus 1 goes back to Step ST3. In Step ST8, the reproducing apparatus 1 determines whether the reproduction operation is completed.

### (3) Switching Between Higher Rate and Lower Rate

### Switching on the Basis of Signal Quality

Sampling at a lower rate, such as the half rate, can decrease the amount of information concerning the time-base components to degrade the decoding result. Specifically, the BER (Byte Error Rate) derived from the correction result in the ECC circuit 45 can be increased. However, the apparatus is not damaged if the BER is 5×10⁻³ or less in view of the error correction capability of HD DVDs or DVDs in related art. Accordingly, if the quality of the reproduction signal in the PUH 10 is sufficiently higher than the above reference value (for example, 10⁻⁵ or less), the reproduction operation at the lower rate causes no problem. Performing the reproduction operation at a higher rate only if the BER is increased can keep the balance between the performance and the power consumption.

Although the sampling-rate switching control circuit 53 may be configured so as to switch the sampling rate on the basis of the BER information supplied from the ECC circuit 45, it is necessary to ensure at least the data size called an ECC block (182×208 Bytes in DVDs in related art and a double of 182×208 Bytes in HD DVDs) in order to measure the BER. Accordingly, this configuration is suitable for the rate switching in rereading (the operation of reading the same ECC black again because any uncorrectable error) but is impractical in switching of the sampling rate in real time (during the data transfer) because of too many delays.

According to the first embodiment of the present invention, as shown in FIG. 2, the signal quality evaluation circuit 52 is provided in the reproducing apparatus 1 to calculate an evaluation index of the quality of the reproduction signal.

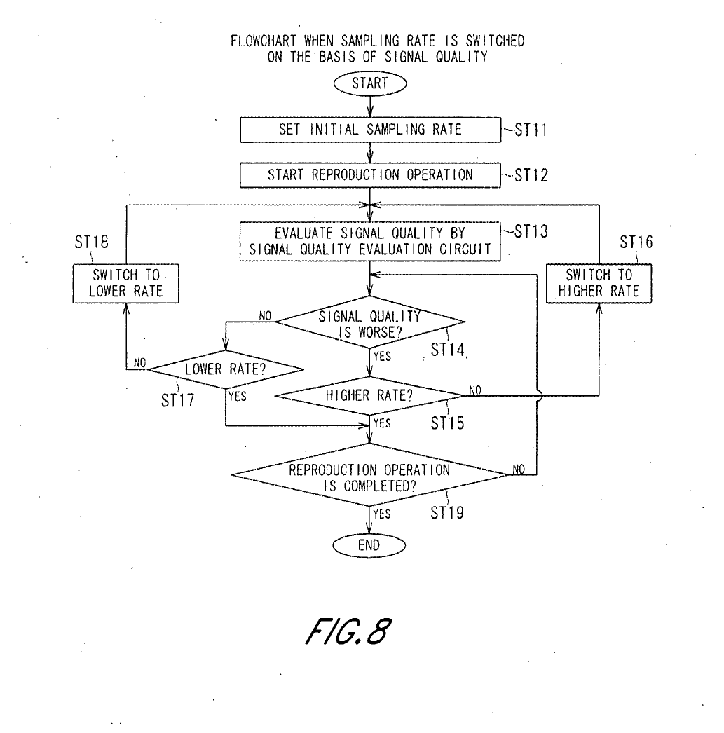

FIG. 8 is a flowchart showing an example of a process of switching the sampling rate on the basis of the signal quality.

Referring to FIG. 8, in Step ST11, the reproducing apparatus 1 sets an initial sampling rate (either of higher or lower sampling rate). In Step ST12, the reproducing apparatus 1 starts the reproduction operation.

In Step ST13, the signal quality evaluation circuit 52 evaluates an index of the signal quality. For example, an equalization error mean square value calculated on the basis of an equalization error signal supplied from the Viterbi decoder 43, a simulated bit error rate (SbER), a partial response signal-to-noise ratio (PRSNR), or a sequence amplitude margin (SAM) is used as the evaluation index of the signal quality.

If the evaluation index of the signal quality is worse than a predetermined threshold (the determination in Step ST 14 is affirmative) and if the lower sampling rate is used (the determination in Step ST15 is negative), then in Step ST16, the reproducing apparatus 1 switches the sampling rate from the lower rate to the higher rate to improve the signal quality.

In contrast, if the evaluation index of the signal quality is better than the predetermined threshold (the determination in Step ST14 is negative) and if the higher sampling rate is used (the determination in Step ST17 is negative), then in Step ST18, the reproducing apparatus 1 switches the sampling rate from the higher rate to the lower rate to reduce the power consumption.

### (4) Switching Between Higher Rate and Lower Rate

### Switching During Data Transfer

The timing of the rate switching is important during the data transfer. The rate switching is accompanied by switching of the initial equalization coefficient or the sampling clock to prevent the switching from being smoothly performed. As a result, the data can be damaged or any loss of the data can be caused during the rate switching.

Accordingly, according to the first embodiment of the present invention, the switching between the higher rate and the lower rate is performed during a period other than the period when the user data is reproduced (the period when the data is transferred). The period other than the period when the user data is reproduced is exemplified by a reproduction period in a VFO (Variable Frequency Oscillator) area.

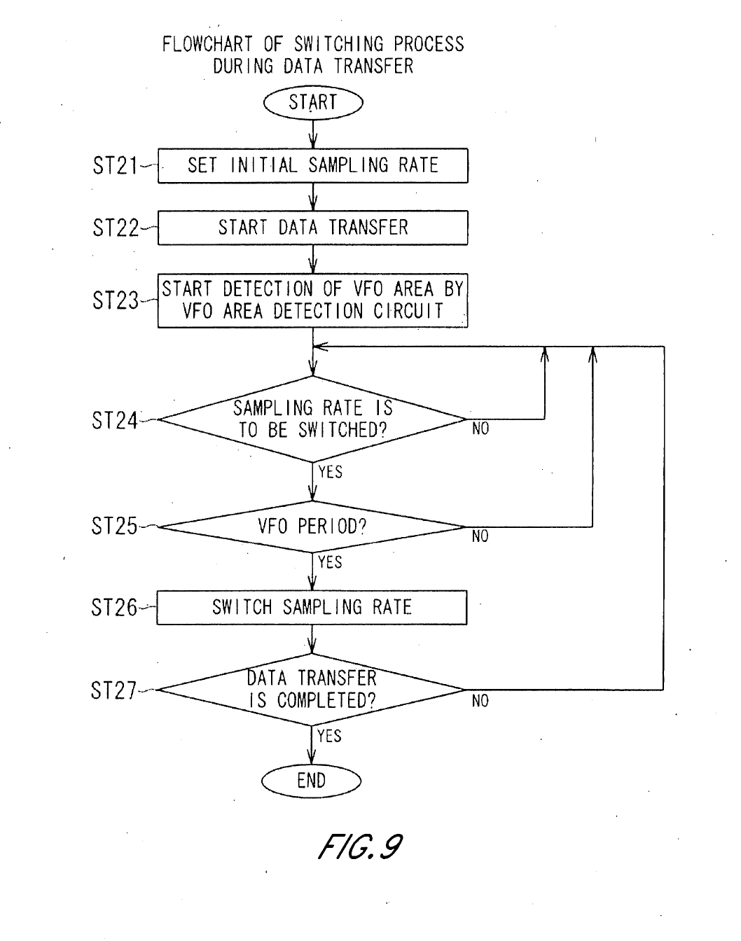

FIG. 9 is a flowchart showing an example of a process of detecting the VFO area and switching the sampling rate between the lower rate and the higher rate during the reproduction period in the VFO area.

Referring to FIG. 9, in Step S21, the reproducing apparatus 1 sets the sampling rate to the higher rate or the lower rate. In Step ST22, the reproducing apparatus 1 starts the data transfer.

In Step ST23, the reproducing apparatus 1 detects the VFO area. The detection of the VFO area is performed by the VFO area detection circuit 51.

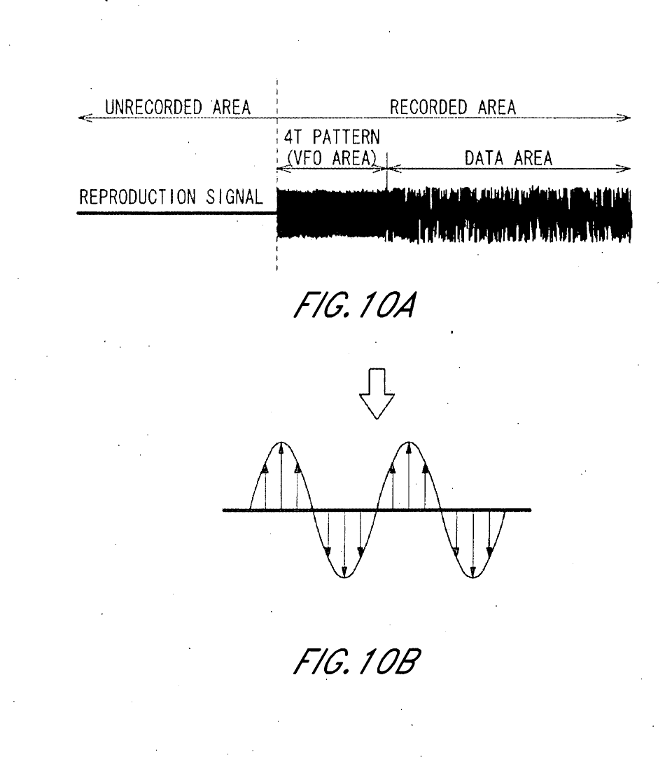

FIG. 10A shows the concept of the VFO area included in the reproduction signal. The VFO area is provided at the beginning of a user area in the reproduction signal. A 4T pattern continuously appears in the VFO area. An example of the 4T pattern is shown in FIG. 10B. The switching of the rate in the VFO area has the advantage of easy acquisition of the phase control because the 4T pattern continuously appears. In addition, since the VFO area is not within the user data, the user data is protected even if any loss of data occurs.

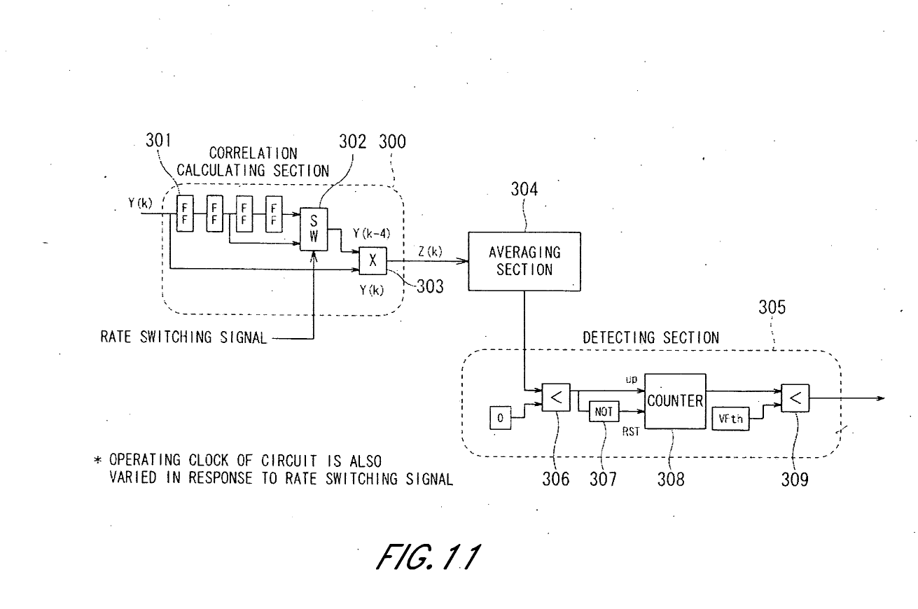

The VFO area can be detected by using the VFO area detection circuit 51 having, for example, a configuration shown in FIG. 11 on the basis of the autocorrelation of the 4T pattern.

Referring to FIG. 11, the VFO area detection circuit 51 includes a correlation calculating section 300, an averaging section 304, and a detecting section 305.

The correlation calculating section 300 calculates the autocorrelation of an input signal to detect a constant periodical pattern specific to the VFO area. Specifically, in the correlation calculating section 300, flip-flops 301 are used to delay an input signal Y(k) for 4T. In other words, the output from the flip-flops 301 is denoted by Y(k−4) delayed from the input signal Y(k) by 4T.

A multiplier circuit 303 in the correlation calculating section 300 calculates Y(k)*Y(k−4). The 4T waveform pattern shown in FIG. 10B, which appears in the VFO area, has reverse-phase autocorrelation, the maximum negative correlation, with the pattern after 4T. Even if the oscillation frequency of the VCO 21 is slightly shifted from the channel rate of the reproduction signal, the VFO area exhibits the strong negative autocorrelation with the 4T pattern. Since the actual reproduction signal includes various noise components, the averaging section 304 perform an averaging process to remove the noise components.

A counter 308 in the detecting section 305 counts up by one if the “UP input” is “1” and the output from the counter 308 is reset to zero if the “RST input is “1”. In other words, the counter 308 is counted up if a negative value is output from the averaging section 304 (in this case, the output of a comparator 306 is “1”) and the counter 308 is reset to zero if a positive value is output from the averaging section 304 (in this case, the output of an inverter 307 is “1”).

The output from the counter 308 is compared with a predetermined threshold (VFth) by a comparator 309. If the output from the counter 308 is larger than the threshold (VFth), the detection signal from the VFO area becomes “1”. With this configuration, the detection signal from the VFO area becomes “1” after about VFth+α bits since the reproduction operation in the VFO area is started and the detection signal from the VFO area becomes “0” almost simultaneously with the completion of the reproduction operation in the VFO area. It is possible to detect an occurrence of the VFO area in the above manner even in a certain level of the asynchronous state.

However, at the half rate, since the two flip-flops 301 cause the delay 4T, as shown in FIG. 11, a switch 302 is used to switch the destination of the multiplier circuit 303 in response to the rate switching signal.

In HD DVDs (HD DVD-Rs, HD DVD-RWs, and HD DVD-RAMs) supporting recording and reproduction, wobble signals may be used to detect the VFO area.

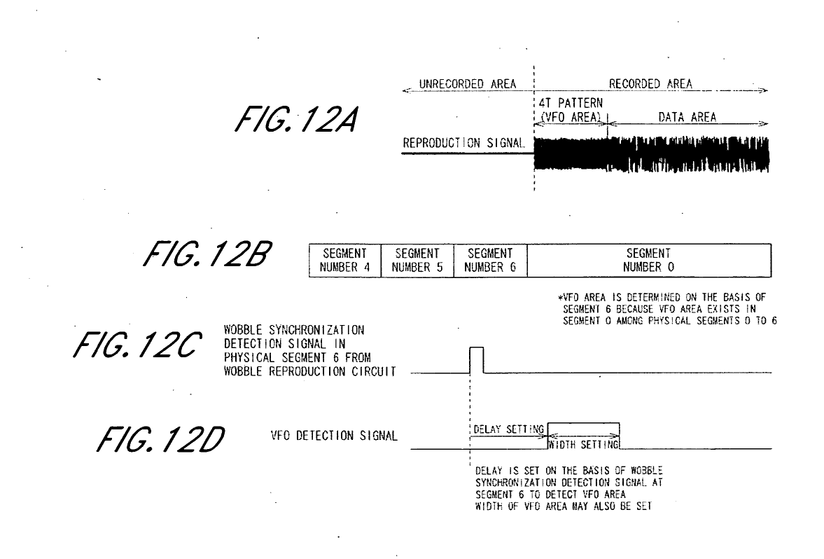

FIGS. 12A to 12D illustrate the relationship between the VFO area of reproduction signal and a wobble signal. The wobble signal has a physical address on the recording medium D recorded thereon. The physical address includes physical segment numbers 0 to 6. The VFO area exists in the physical segment 0 (refer to FIG. 12B).

Accordingly, a wobble synchronization detection signal (refer to FIG. 12C) in the physical segment 6 can be received from a circuit (not shown) for reproduction and demodulation of the wobble signal to estimate the VFO area in the subsequent physical segment 0.

For example, as shown in FIG. 12D, the VFO area is set to appear after a predetermined delay time elapsed since the wobble synchronization detection signal in the physical segment 6. The width of the VFO area may also be estimated.

Referring back to FIG. 9, in Step ST24, the reproducing apparatus 1 determines whether the sampling rate is to be switched concurrently with the detection of the VFO area. The determination is based on, for example the evaluation index of the signal quality described above.

If the reproducing apparatus 1 determines that the sampling rate is to be switched, in Step ST25, the reproducing apparatus 1 determines whether the reproduction signal reaches the VFO area. If the reproducing apparatus 1 determines that the reproduction signal reaches the VFO area, then in Step ST26, the reproducing apparatus 1 switches the sampling rate. If the reproducing apparatus 1 determines that the reproduction signal does not reach the VFO area, the reproducing apparatus 1 waits until the reproduction signal reaches the VFO area and switches the sampling rate. In Step ST27, the reproducing apparatus 1 determines whether the data transfer is completed.

In the switching of the sampling rate, the sampling-rate switching control circuit 53 supplies the rate switching signal to the pre-equalizer 12 and to each circuit supporting varied rates, as described above.

Setting the control gain of each circuit supporting varied rates (the offset control circuit 41, the asymmetry control circuit 42, and the phase comparator 24) to a higher value for a predetermined time period allows high-speed acquisition operation and smooth rate switching.

However, it is not possible to perform the adaptive learning in the VFO area because the adaptive learning tends to diverge in principle with a signal having a higher autocorrelation. Accordingly, only the initial equalization coefficient is set in the VFO area and the adaptive learning is started after the detection signal of the VFO area falls. However, the detection signal can temporarily fall during the rate switching. In such a case, the adaptive learning is performed when the second detection signal of the VFO area falls, the second detection signal being detected immediately after the rate switching.

### (5) Second Embodiment

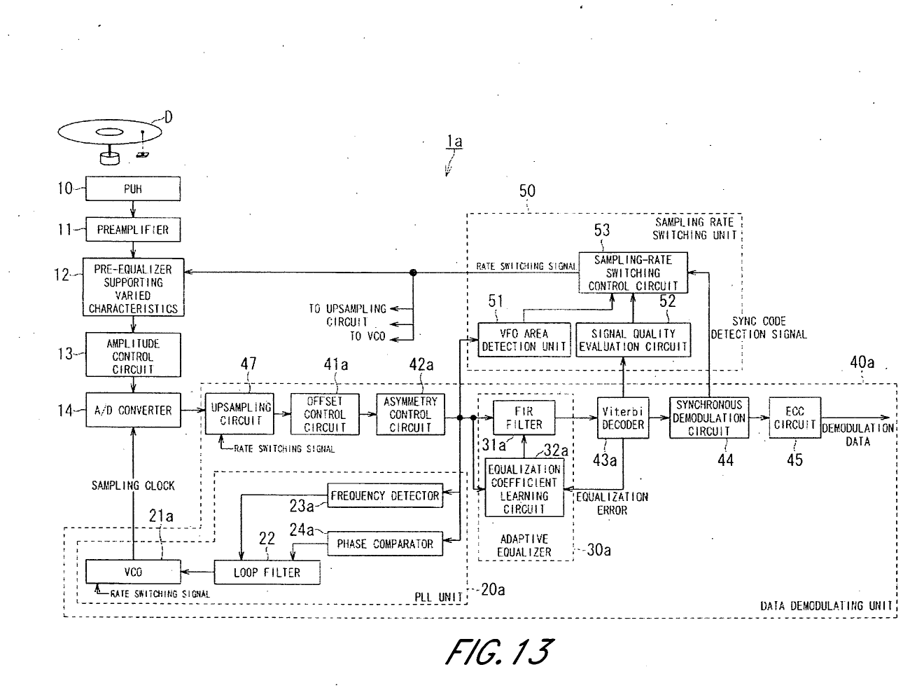

FIG. 13 is a block diagram showing an example of the configuration of an apparatus 1a for reproducing data on a recording medium (hereinafter referred to as a reproducing apparatus 1a) according to a second embodiment of the present invention. In the reproducing apparatus 1a according to the second embodiment of the present invention, only the sampling rate in the A/D converter 14 is switched from a higher rate to a lower rate. The downstream digital circuit components operate at the higher rate (the channel rate).

The lower sampling rate is not limited to the half rate and is set to a rate two-thirds of the channel rate in the second embodiment of the present invention.

Digital processing circuits have increasingly lowered the power consumption in recent years. In the reproducing apparatus 1a, the A/D converter 14 performing high-speed analog processing consumes several tens percent of the entire power. Accordingly, decreasing the sampling rate only in the A/D converter 14 can achieve power saving.

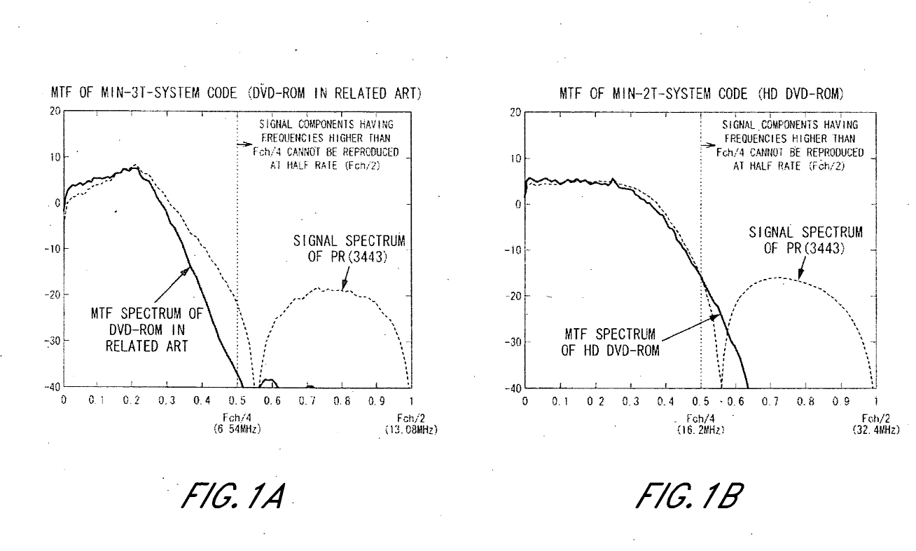

The lower sampling rate is set to the rate two-thirds of the channel rate in the second embodiment of the present invention because the signal bandwidth exists in an area having frequencies higher than one-fourth of the channel rate in HD DVDs adopting the min-2T-system code, as shown in FIG. 1B. Although the effect of the frequency components in the area having the frequencies higher than one-fourth of the channel rate cannot be completely ignored at the half rate, the sampling rate that is equal to two thirds of the channel rate can be used to almost ignore such an effect.

An operation of the reproducing apparatus 1a according to the second embodiment of the present invention will now be described.

At the higher rate (the channel rate), the reproduction signal subjected to the A/D conversion in the A/D converter 14 is supplied to an upsampling circuit 47. Since the sampling rate is set to the higher rate, it is not necessary to perform an upsampling process. Accordingly, the reproduction signal passes through the upsampling circuit 47 and is supplied an offset control circuit 41a. Since the subsequent processing is the same as in the first embodiment, a description is omitted herein.

After the rate switching signal is output from the sampling-rate switching control circuit 53, the sampling clock in the A/D converter 14 is switched from the higher rate to the lower rate. In this case, the sampling clock in the A/D converter 14 is set to two thirds of the channel rate.

In the case of a single speed HD DVD, since the channel rate is equal to 64.8 MHz, the reproduction signal is sampled at a sampling rate of 43.2 MHz. The reproduction signal subjected to the A/D conversion at this sampling clock is supplied to the upsampling circuit 47 where the reproduction signal is subjected to data interpolation into a channel rate of 64.8 MHz and the interpolated signal is output. The subsequent processing is the same as at the higher rate and is performed at the channel rate. According to the second embodiment of the present invention, since the digital circuit downstream of the upsampling circuit 47 operates at the sampling rate corresponding to the channel rate regardless of the higher rate and the lower rate, the same configuration as in the first embodiment can be used and there is no need for the circuit components to support varied rates.

However, since it is necessary to switch the sampling clock to be supplied to the A/D converter 14, the rate switching signal is supplied to a VCO 21a where the division ratio is controlled so as to output the clock signal at a rate two thirds of the channel rate. The rate switching signal may be supplied to the loop filter 22 where the division ratio is controlled so as to output the clock signal at a rate two thirds of the channel rate.

### (6) Third Embodiment

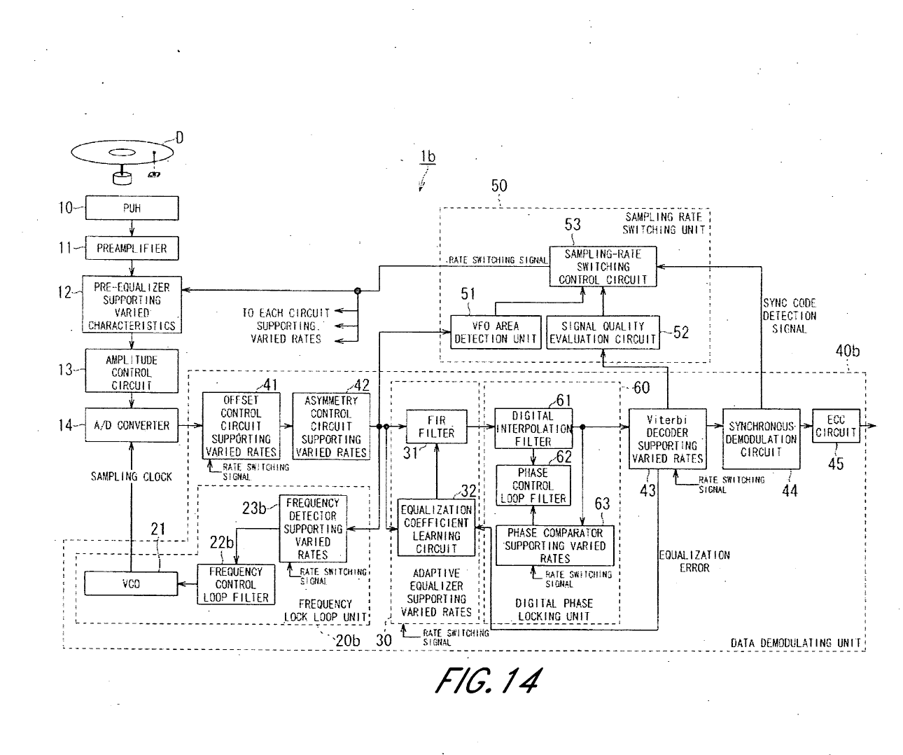

FIG. 14 is a block diagram showing an example of the configuration of an apparatus 1b for reproducing data on a recording medium (hereinafter referred to as a reproducing apparatus 1b) according to a third embodiment of the present invention. The third embodiment is based on an element technique called an asynchronous sampling method, which has been already put to practical use in, for example, hard disk devices.

An example of application of the asynchronous sampling method to an optical disc is disclosed in JP-A 2001-195830. In the asynchronous sampling method, the A/D converter 14 samples the reproduction signal asynchronously with the channel clock included in the reproduction signal and the signal asynchronously sampled is synchronized with the channel clock in a downstream digital phase locking unit 60 including a digital interpolation filter 61.

This signal processing method has several advantages. Particularly, since the phase control loop need not include the A/D converter 14, it is possible to ignore any delay in the A/D converter 14 and to ensure sufficient phase margin in the control loop.

In addition, when the output signal from the adaptive equalizer 30 is used to control the phase, as shown in FIG. 14, it is possible to use a signal that is output from the equalizer and that is appropriately equalized, so that stable phase control can be achieved even if the phase control is affected by, for example, any tangent tilt (a tilt of the disk with respect to the PUH 10 in a linear direction on the disk).

Since this asynchronous sampling method is presented as a reference method in HD DVD standard, it is necessary to measure SbER and PRSNR by this method.

In this asynchronous sampling method, the asynchronous sampling rate should generally be set to a rate five to ten percent higher than the reproduction rate in order to ensure the accuracy of the digital interpolation filter 61 used for the phase control. In HD DVD standard, the asynchronous sampling rate is set to 72 MHz, which is 1.1 times higher than the channel rate.

Accordingly, when the HD DVD standard is applied to the third embodiment of the present invention, for example, the higher sampling rate is set to a rate 1.1 times higher than the channel rate and the lower sampling rate is set to a rate 0.55 (0.5×1.1) times higher than the channel rate.

An operation of the reproducing apparatus 1b according to the third embodiment of the present invention will now be described with reference to FIG. 14. The operation of the components described in detail in the first embodiment of the present invention will not be described here.

At the higher rate, the digital reproduction signal subjected to the A/D conversion at the sampling rate 1.1 times higher than the channel rate is subjected to the waveform shaping in the offset control circuit 41 supporting the varied rates and the asymmetry control circuit 42 supporting varied rate. Since both the offset control circuit 41 and the asymmetry control circuit 42 support asynchronous processing, the offset control circuit 41 and the asymmetry control circuit 42 are capable of operating in the asynchronous state in which the sampling rate is 1.1 times higher than the channel rate.

The adaptive equalizer 30 performs the adaptive learning to the signal subjected to the waveform shaping to equalize the signal to a desired PR class. The adaptive learning should be performed so as to equalize the waveform at the sampling rate 1.1 times higher than the channel rate. However, since the downstream Viterbi decoder 43 operates at the channel rate, the equalization error signal supplied from the Viterbi decoder 43 to the equalization coefficient learning circuit 32 in the adaptive equalizer 30 also has the channel rate. In other words, since the reproduction signal supplied to the adaptive equalizer 30 is asynchronous with the equalization error signal supplied thereto, it is necessary for the equalization coefficient learning circuit 32 to synchronize the reproduction signal with the equalization error signal to determine the amount of update of the equalization coefficient.

The signal output from the adaptive equalizer 30 is supplied to the digital interpolation filter 61. A phase comparator 63 supporting varied rates and a phase control loop filter 62 control the phase of the signal supplied to the digital interpolation filter 61 so as to be synchronized with the channel rate. The digital interpolation filter 61 is, for example, an FIR filter having several taps, as disclosed in JP-A 2001-195830, and selects a tap coefficient on the basis of the phase information.

Since the reproduction signal supplied from the digital interpolation filter 61 is synchronized with the channel rate, the reproduction signal is supplied to the Viterbi decoder 43 where the reproduction signal is decoded into binary data, and the binary data is supplied to the downstream components.

A frequency detector 23b supporting varied rates in a frequency lock loop unit 20b detects a difference in frequency between the frequency of the reproduction signal subjected to the waveform shaping and the rate 1.1 times higher than the channel rate. The frequency detector 23b supplies the difference in frequency to a frequency control loop filter 22b. The frequency control loop filter 22b controls the VCO 21 so as to generate an asynchronous clock signal having a rate 1.1 times higher than the channel rate.

The basic operation is the same as the above operation also when the lower sampling rate is selected in response to the rate switching signal. The sampling rate in the A/D converter 14 is set to a rate 0.55 times higher than the channel rate. The data sampled at the sampling rate 0.55 times higher than the channel rate is output from the digital interpolation filter 61 at a rate (half rate) 0.5 times higher than the channel rate.

Although both the oversampling ratios of the higher rate and the lower rate are 10% in the third embodiment of the present invention, it is not necessary to set the same oversampling ratio for the higher rate and the lower rate. The oversampling ratio for the higher rate may be different from that for the lower rate.

### (7) Fourth Embodiment

A binary slicing circuit, on which the DVD standard in the related art adopting the min-3T-system code is premised, can be used to ensure a desired BER.

Since the read-in area on each HD DVD adopting the min-2T-system code has a liner density half of that of the data area, the binary slicing circuit can be used to read data.

With the object of the power consumption, the binary slicing circuit consumes much lower power than the PRML signal processing method because, for example, the A/D converter is not necessary.

An apparatus 1c for reproducing data on a recording medium (hereinafter referred to as a reproducing apparatus 1c) according to a fourth embodiment of the present invention includes both a binary slicing circuit and a PRML signal processing circuit and performs switching between the binary slicing circuit and the PRML signal processing circuit on the basis of the signal quality.

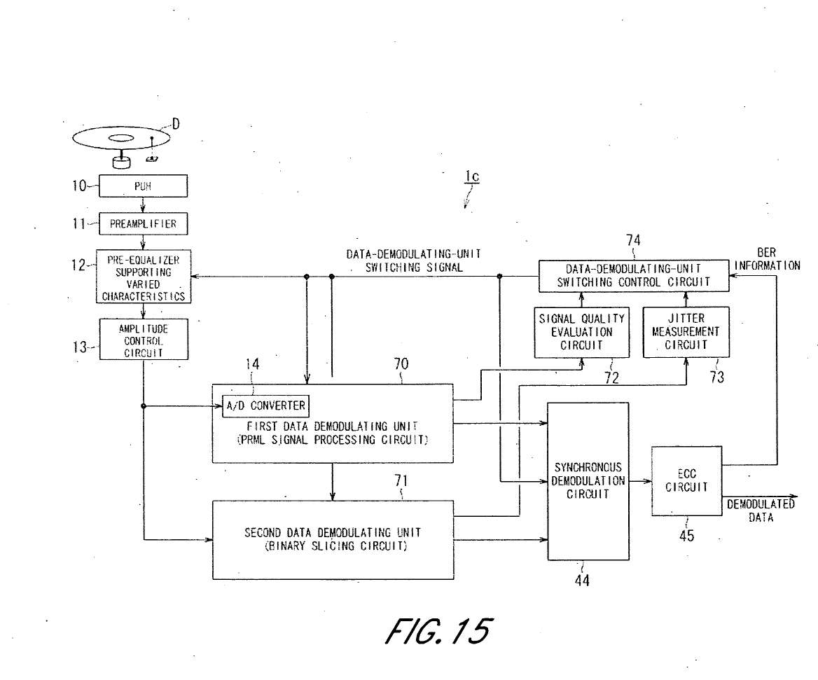

FIG. 15 is a block diagram showing an example of the configuration of the reproducing apparatus 1c according to the fourth embodiment of the present invention. The reproducing apparatus 1c includes both a PRML signal processing circuit (a first data demodulating unit) 70 and a binary slicing circuit (a second data demodulating unit) 71.

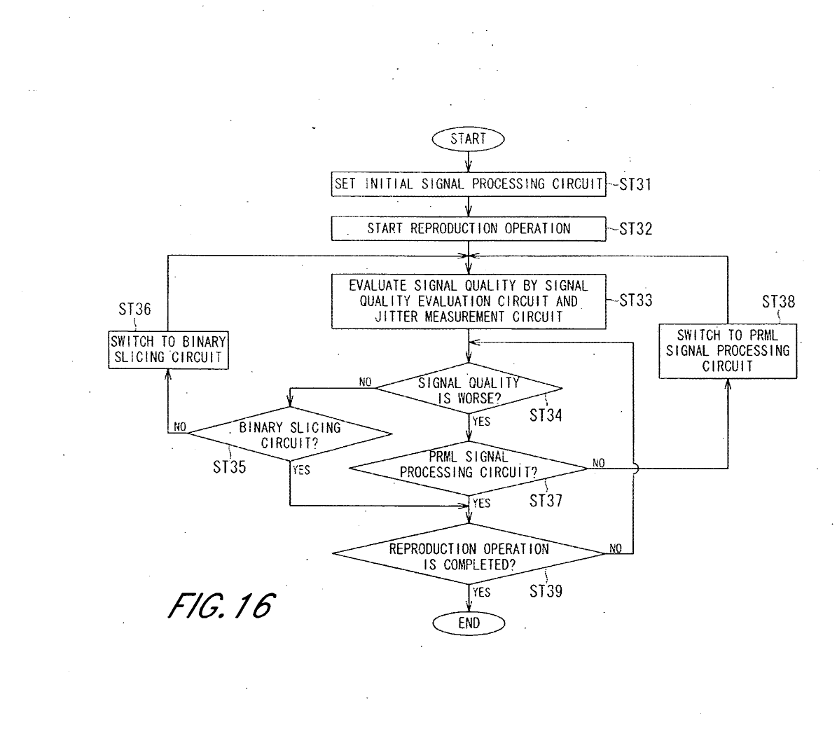

FIG. 16 is a flowchart showing an example of a reproduction operation of the reproducing apparatus 1c according to the fourth embodiment of the present invention.

Referring to FIG. 16, in Step ST31, the reproducing apparatus 1c selects either the binary slicing circuit 71 or the PRML signal processing circuit 70 as the initial state and sets the selected circuit. In Step ST32, the reproducing apparatus 1c starts the reproduction operation.

As in the first embodiment of the present invention, the analog reproduction signal (radio frequency (RF) signal) of which the amplitude control is completed in the amplitude control circuit 13 is supplied to both the PRML signal processing circuit 70 and the binary slicing circuit 71. However, only one of the PRML signal processing circuit 70 and the binary slicing circuit 71 operates in response to a data-demodulating-unit switching signal supplied from a data-demodulating-unit switching control circuit 74 described below. For example, if the binary slicing circuit 71 is selected, the PRML signal processing circuit 70 does not operate because of gated clock and the power of an A/D converter 14 is reduced to prevent the power from being wastefully consumed.

The binary data demodulated by the PRML signal processing circuit 70 or the binary slicing circuit 71 is supplied to the synchronous demodulation circuit 44. The synchronous demodulation circuit 44 operates in the manner described above in the first embodiment to convert the binary data into demodulation data, which is Byte data. The demodulation data is supplied to the ECC circuit 45 where the demodulation data is subjected to error correction. The ECC circuit 45 counts the number of errors in the ECC block subjected to the error correction to measure the BER. The BER information is supplied to the data-demodulating-unit switching control circuit 74.

For example, when the binary slicing circuit 71 is selected, the data-demodulating-unit switching control circuit 74 does not perform the switching if the BER information indicates that a sufficiently low error rate is maintained. In contrast, the data-demodulating-unit switching control circuit 74 outputs the data-demodulating-unit switching signal to perform switching from the binary slicing circuit 71 to the PRML signal processing circuit 70 if the error rate is lowered or if an uncorrectable error occurs to read the data again. As described above, the binary slicing circuit 71, which does not use the A/D converter 14, is used if a sufficient high signal quality is maintained while the PRML signal processing circuit 70 is used if the signal quality is to be improved.

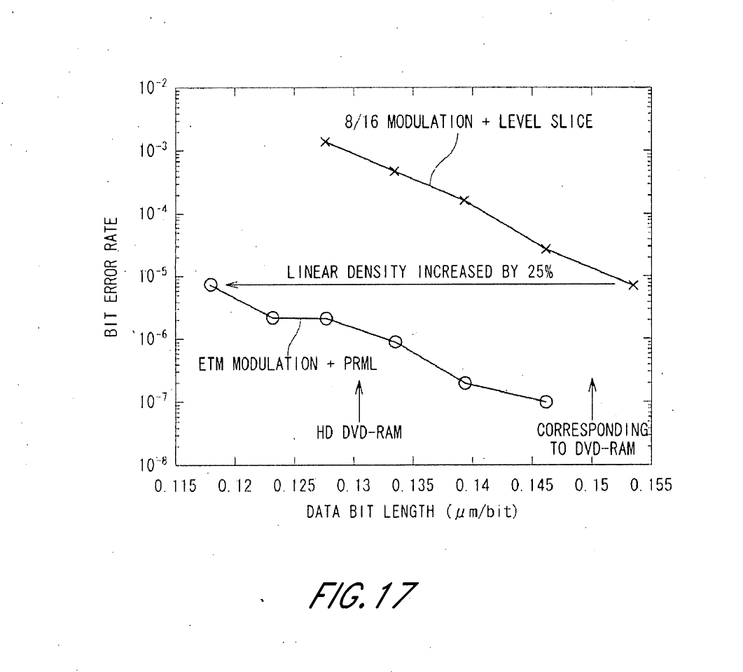

A difference in performance between the binary slicing circuit 71 and the PRML signal processing circuit 70 involved in the improvement of the signal quality is shown in FIG. 17.

FIG. 17 shows examples of the relationship between the linear density and the BER in the case of the binary slicing method (the Eight to Sixteen Modulation (EFM Plus) in DVDs in related art) and the PRML signal processing method (the ETM in HD DVDs). “DVD-RAM” in FIG. 17 assumes a light source emitting light having a wavelength of 405 nm.

As apparent from FIG. 17, since the intersymbol interference is increased when the linear density is high (the area indicated by “HD DVD-RAM”), the PRML signal processing method, which permits the intersymbol interference, exhibits a more superior performance (lower bER). Even when the linear density is rather low (the area indicated by “DVD-RAM”), the PRML signal processing method has superiority over the binary slicing method. Accordingly, both in the DVDs in related art and the HD DVDs, the PRML signal processing method can be selected to improve the performance.

As described above in the first embodiment, since it takes time to release the measurement result of the BER, the performance may be evaluated with performance evaluating means that takes only a short time to release the measurement result.

If the PRML signal processing circuit 70 is selected, an evaluation index generated by processing the equalization error signal, such as the SbER, output from the PRML signal processing circuit 70 is used.

If the binary slicing circuit 71 is selected, the amount of timing fluctuation (the amount of jitter) between a data edge and a clock edge is generally used as the evaluation index.

In the reproducing apparatus 1c shown in FIG. 15, a signal quality evaluation circuit 72 measures an SbER to supply the measured SbER to the data-demodulating-unit switching control circuit 74 and a jitter measurement circuit 73 measures an amount of jitter to supply the measured amount of jitter to the data-demodulating-unit switching control circuit 74. The signal quality evaluation circuit 72, the jitter measurement circuit 73, and the data-demodulating-unit switching control circuit 74 form a demodulation selecting unit.

Referring back to FIG. 16, in Step ST33, the signal quality evaluation circuit 72 and the jitter measurement circuit 73 evaluate the signal quality.

If the signal quality is low (the determination in Step ST34 is affirmative) and if the binary slicing circuit 71 is selected (the determination in Step ST37 is negative), then in Step ST38, the reproducing apparatus 1c performs switching from the binary slicing circuit 71 to the PRML signal processing circuit 70.

In contrast, if the signal quality is high (the determination in Step ST34 is negative) and if the PRML signal processing circuit 70 is selected (the determination in Step S35 is negative), then in Step ST36, the reproducing apparatus 1c performs switching from the PRML signal processing circuit 70 to the binary slicing circuit 71.

The data-demodulating-unit switching signal is also supplied to the pre-equalizer 12 supporting varied characteristics. The pre-equalizer 12 is configured so as to perform switching between equalizer characteristics optimal to the PRML signal processing circuit 70 and equalizer characteristics optimal to the binary slicing circuit 71.

For example, if the PRML signal processing circuit 70 is selected, the evaluation index of the signal quality, such as the SbER, is set so as to be a minimum value. If the binary slicing circuit 71 is selected, the amount of jitter is set so as to be a minimum value. Since different parts of the reproduction signal are evaluated when the evaluation index of the signal quality is used and when the amount of jitter is used, the optimal characteristics for the evaluation index of the signal quality do not necessarily coincide with those for the amount of jitter. Consequently, it is desirable that the characteristics be switched depending on the used signal processing circuit.

As described above, in the reproducing apparatuses 1, 1a, and 1b according to the first to third embodiments of the present invention, it is possible to switch from the normal sampling rate to the lower sampling rate even in the min-2T-system code used in HD DVDs without spoiling the operational stability, thus reducing the power consumption.

In the min-3T-system code, appropriately setting the timing of switching from the higher rate to the lower rate allows the switching stability to be improved. In addition, changing the PR class between at the higher rate and at the lower rate improves the performance.

In the reproducing apparatus 1c according to the fourth embodiment of the present invention, the provision of both the PRML method and the binary slicing method without the A/D conversion and the switching between the PRML method and the binary slicing method on the basis of the signal quality allow the power consumption to be reduced while maintaining the signal quality.

Although the optical disc is exemplified as the recording medium in the above description, the embodiments of the present invention are applicable to another recording medium adopting the PRML method, such as a magneto-optical disk or a magnetic disk.

It should be understood by those skilled in the art that various modifications, combinations, sub-combinations and alterations may occur depending on design requirements and other factors insofar as they are within the scope of the appended claims or the equivalents thereof.

What is claimed is:

1. An apparatus for reproducing digital data recorded on a recording medium by a Partial Response Maximum Likelihood method, the digital data being recorded in a code pattern in which the same code continuously appears at least two times, the apparatus comprising:
an analog-to-digital converting unit that is configured to sample an analog reproduction signal recorded on the recording medium and convert the sampled analog reproduction signal into a digital signal;
a sampling rate switching unit that is configured to adaptively switch the sampling rate in the analog-to-digital converting unit from a higher rate to a lower rate; and
a data demodulating unit that is configured to reproduce and demodulate the digital signal subjected to the analog-to-digital conversion in the analog-to-digital converting unit by the Partial Response Maximum Likelihood method in accordance with the switching between the higher rate and the lower rate.

2. The apparatus according to claim 1,
wherein the higher rate is equal to a channel rate, which is a reproduction rate in units of bits recorded on the recording medium, or is higher than the channel rate, and
wherein the lower rate is equal to a half rate that is half of the channel rate or is equal to a rate between the half rate and the channel rate.

3. The apparatus according to claim 1,
wherein the data demodulating unit includes a phase locked loop unit that is configured to lock a frequency and a phase on the basis of the digital signal supplied from the analog-to-digital converting unit to generate a sampling clock having the sampling rate, and
wherein the sampling rate switching unit switches the sampling rate from the higher rate to the lower rate after the phase locked loop unit locks the frequency and the phase.

4. The apparatus according to claim 3,
wherein the phase locked loop unit includes an upsampling unit downstream of the analog-to-digital converting unit, and
wherein the upsampling unit is configured to convert the lower sampling rate at which the analog-to-digital converting unit samples the analog reproduction signal into the higher rate.

5. The apparatus according to claim 1,
wherein the sampling rate switching unit is configured to switch the sampling rate from the higher rate to the lower rate during a period other than the period when user data is reproduced.

6. The apparatus according to claim 5,
wherein the period other than the period when the user data is reproduced is a period when a variable frequency oscillator area is reproduced.

7. The apparatus according to claim 1,
wherein the sampling rate switching unit is configured to calculate a signal-quality evaluation index from the signal output from the data demodulating unit to switch the sampling rate between the higher rate and the lower rate on the basis of the signal-quality evaluation index.

8. The apparatus according to claim 1, further comprising:
a pre-equalizer configured to limit a bandwidth of the analog reproduction signal,
wherein a cutoff frequency of the pre-equalizer is set so as to reduce an effect of an aliasing noise in accordance with a variation in the sampling rate caused by the switching between the higher rate and the lower rate.

9. The apparatus according to claim 1,
wherein the data demodulating unit is configured to select different partial response classes, used in the Partial Response Maximum Likelihood method, at the higher rate and at the lower rate.

10. The apparatus according to claim 9,
wherein a PR(a,b,b,a) class is used at the higher rate and a PR(a,b) class is used at the lower rate.

11. The apparatus according to claim 2,
wherein the data demodulating unit includes:
a frequency lock loop unit that is configured to perform frequency following and sample the analog reproduction signal at a sampling rate higher than the channel rate at the higher rate and perform the frequency following and sample the analog reproduction signal at a sampling rate higher than the half rate at the lower rate; and
a digital phase locking unit that is configured to convert the sampling rate higher than the channel rate into the channel rate and perform phase lock at the higher rate and convert the sampling rate higher than the half rate into the half rate and perform the phase lock at the lower rate.

12. An apparatus for reproducing digital data recorded on a recording medium by a Partial Response Maximum Likelihood method, the apparatus comprising:
an analog-to-digital converting unit that is configured to sample an analog reproduction signal recorded on the recording medium and convert the sampled analog reproduction signal into a digital signal;
a sampling rate switching unit that is configured to adaptively switch the sampling rate in the analog-to-digital converting unit from a higher rate to a lower rate; and
a data demodulating unit that is configured to reproduce and demodulate the digital signal subjected to the analog-to-digital conversion in the analog-to-digital converting unit by the Partial Response Maximum Likelihood method in accordance with the switching between the higher rate and the lower rate,
wherein the sampling rate switching unit is configured to switch the sampling rate from the higher rate to the lower rate during a period other than the period when user data is reproduced.

13. The apparatus according to claim 12,
wherein the period other than the period when the user data is reproduced is a period when a variable frequency oscillator area is reproduced.

14. An apparatus for reproducing digital data recorded on a recording medium by a Partial Response Maximum Likelihood method, the apparatus comprising:
an analog-to-digital converting unit that is configured to sample an analog reproduction signal recorded on the recording medium and convert the sampled analog reproduction signal into a digital signal;
a sampling rate switching unit that is configured to adaptively switches the sampling rate in the analog-to-digital converting unit from a higher rate to a lower rate; and
a data demodulating unit that is configured to reproduce and demodulate the digital signal subjected to the analog-to-digital conversion in the analog-to-digital converting unit by the Partial Response Maximum Likelihood method in accordance with the switching between the higher rate and the lower rate,
wherein the data demodulating unit is configured to select different partial response classes, used in the Partial Response Maximum Likelihood method, at the higher rate and at the lower rate.

15. The apparatus according to claim 14,
wherein a PR(a,b,b,a) class is used at the higher rate and a PR(a,b) class is used at the lower rate.

16. An apparatus for reproducing digital data recorded on a recording medium by a binary slicing method and a Partial Response Maximum Likelihood method, the apparatus comprising:
a first data demodulating unit that includes an analog-to-digital converting unit configured to sample an analog reproduction signal recorded on the recording medium and convert the sampled analog reproduction signal into a digital signal, and to reproduce and demodulate the digital signal subjected to the analog-to-digital conversion in the analog-to-digital converting unit by the Partial Response Maximum Likelihood method;
a second data demodulating unit that is configured to slice the analog reproduction signal into a binary value and demodulate the binary value; and
a demodulation selecting unit that, at least if the second data demodulating unit is selected, is configured to stop the operation of the first data demodulating unit to selectively perform switching between the first data demodulating unit and the second data demodulating unit.

17. The apparatus according to claim 16,
wherein the demodulation selecting unit is configured to select the second data demodulating unit if a bit error rate of the demodulated data is lower than or equal to a predetermined threshold and select the first data demodulating unit if the bit error rate of the demodulated data exceeds the predetermined threshold.

18. The apparatus according to claim 16,
wherein the demodulation selecting unit is configured to calculate a signal-quality evaluation index from the signal output from the first data demodulating unit and switch the first data demodulating unit to the second data demodulating unit if the signal-quality evaluation index is better than a predetermined quality, and
wherein the demodulation selecting unit is configured to calculate an amount of jitter from the signal output from the second data demodulating unit and switch the second data demodulating unit to the first data demodulating unit if the amount of jitter is greater than a predetermined amount.

19. A reproducing method for an apparatus for reproducing digital data recorded on a recording medium by a Partial Response Maximum Likelihood method, the digital data being recorded in a code pattern in which the same code continuously appears at least two times, the method comprising the steps of:
sampling an analog reproduction signal recorded on the recording medium and converting the sampled analog reproduction signal into a digital signal;
adaptively switching the sampling rate in the analog-to-digital conversion from a higher rate to a lower rate; and
reproducing and demodulating the digital signal subjected to the analog-to-digital conversion by the Partial Response Maximum Likelihood method in accordance with the switching between the higher rate and the lower rate.

20. A reproducing method for an apparatus for reproducing digital data recorded on a recording medium by a Partial Response Maximum Likelihood method, the method comprising the steps of:
sampling an analog reproduction signal recorded on the recording medium and converting the sampled analog reproduction signal into a digital signal;
adaptively switching the sampling rate in the analog-to-digital conversion from a higher rate to a lower rate; and
reproducing and demodulating the digital signal subjected to the analog-to-digital conversion by the Partial Response Maximum Likelihood method in accordance with the switching between the higher rate and the lower rate,
wherein the switching step switches the sampling rate from the higher rate to the lower rate during a period other than the period when user data is reproduced.

21. A reproducing method for an apparatus for reproducing digital data recorded on a recording medium by a Partial Response Maximum Likelihood method, the method comprising the steps of:
sampling an analog reproduction signal recorded on the recording medium and converting the sampled analog reproduction signal into a digital signal;
adaptively switching the sampling rate in the analog-to-digital conversion from a higher rate to a lower rate; and
reproducing and demodulating the digital signal subjected to the analog-to-digital conversion by the Partial Response Maximum Likelihood method in accordance with the switching between the higher rate and the lower rate,
wherein the reproducing and demodulating step selects different partial response classes, used in the Partial Response Maximum Likelihood method, at the higher rate and at the lower rate.

22. A reproducing method for an apparatus for reproducing digital data recorded on a recording medium by a binary slicing method and a Partial Response Maximum Likelihood method, the method comprising:
a first data demodulating step of reproducing and demodulating a digital signal subjected to analog-to-digital conversion in an analog-to-digital converting unit by the Partial Response Maximum Likelihood method, the analog-to-digital converting unit sampling an analog reproduction signal recorded on the recording medium and converting the sampled analog reproduction signal into the digital signal;
a second data demodulating step of slicing the analog reproduction signal into a binary value and demodulating the binary value; and
a demodulation selecting step of stopping the first data demodulating step, at least if the second data demodulating step is selected, to selectively perform switching between the first data demodulating step and the second data demodulating step.
